(19) United States
(12) Patent Application Publication
(10) Pub. No.: US 2007/0272313 A1
(43) Pub. Date: Nov. 29, 2007

(54) PRESSURE REGULATOR WITH IMPROVED OUTLET PRESSURE CONTROL

(76) Inventor: Charles M. Olds, Martindale, TX (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/751,907

(22) Filed: May 22, 2007

Related U.S. Application Data
(60) Provisional application No. 60/802,633, filed on May 23, 2006.

(51) Int. Cl. G05D 16/06

(52) U.S. Cl. 137/613

(57) ABSTRACT

A two-stage pressure regulator comprising a regulator housing comprising a bonnet, a first regulator body having a top connected to the bonnet and a bottom connected to a second regulator body. The regulator housing has an inlet, a first flow path, a second flow path and an outlet. The regulator housing has a first regulating cavity formed between the first regulating body and the second regulating body and a second regulating cavity formed between the bonnet and the first regulating body. A first diaphragm is in the first regulating cavity and a second diaphragm is in the second regulating cavity. A first regulating assembly is operatively connected to the first diaphragm for preventing fluid flow through the first flow path and a second regulating assembly is operatively connected to the second diaphragm for preventing fluid flow through the second flow path.

### FIELD OF THE INVENTION

This invention is applicable to a wide range of gas pressure-regulating applications, but is designed for particularly advantageous use in propane outdoor cooking appliance applications.

### BACKGROUND OF THE INVENTION

Heretofore, the gas pressure output of a pressure regulator has been controlled by applying the inlet pressure against a flexible diaphragm surface area that is balanced with a spring force set at or adjusted to the desired output gas pressure. An improved apparatus is desired.

### SUMMARY OF THE PRESENT INVENTION

An aspect of the present invention is to provide a two-stage pressure regulator comprising a regulator housing, a first diaphragm, a second diaphragm, a first regulating assembly and a second regulating assembly. The regulator housing comprises a bonnet, a first regulator body connected to the bonnet, and a second regulator body connected to the first regulator body. The first regulator body having a top and a bottom, with the bonnet connected to the top of the first regulator body and the second regulator body connected to the bottom of the first regulator body. The regulator housing has an inlet and an outlet. The regulator body further has a first flow path and a second flow path between the inlet and the outlet, such that the regulator body is configured to have at least some fluid flowing through the regulator body from the inlet, through the first flow path, then through the second flow path and then through the outlet. The regulator housing also has a first regulating cavity formed between the first regulating body and the second regulating body. The regulator housing further has a second regulating cavity formed between the bonnet and the first regulating body. The first diaphragm is in the first regulating cavity and the second diaphragm is in the second regulating cavity. The first regulating assembly is operatively connected to the first diaphragm for preventing fluid flow through the first flow path. The second regulating assembly is operatively connected to the second diaphragm for preventing fluid flow through the second flow path.

Another aspect of the present invention is to provide a pressure regulator comprising a regulator housing having an inlet tube, an outlet tube and a fluid path between the inlet tube and the outlet tube. The regulator body has at least one regulating cavity formed therein. The pressure regulator further includes at least one diaphragm in the at least one regulating cavity and a regulating assembly operatively connected to the at least one diaphragm with a connection member for preventing fluid flow through the fluid path. The fluid path has a constriction and the regulating assembly has a closure member for covering the constriction to prevent the fluid flow through the fluid path. The constriction has an entrance and an exit whereby fluid flows through the constriction from the inlet tube and the entrance and out of the constriction through the exit, with the closure member covering the exit of the constriction. The constriction is directly adjacent the outlet tube such that fluid traveling through the regulator housing can flow from the constriction to the outlet tube without entering the at least one cavity, without encountering the at least one diaphragm and without encountering the connection member.

Yet another aspect of the present invention is to provide a two-stage pressure regulator comprising a regulator housing, a first diaphragm, a second diaphragm, a first regulating assembly and a second regulating assembly. The regulator housing comprises a bonnet, a first regulator body connected to the bonnet, and a second regulator body connected to the first regulator body. The regulator housing has an inlet tube and an outlet tube. The regulator body has a first flow path and a second flow path, with the first flow path being located between the inlet tube and the second flow path and the second flow path being located between the first flow path and the outlet tube. The regulator housing further has a first regulating cavity formed between the first regulating body and the second regulating body and a second regulating cavity formed between the bonnet and the first regulating body. The first diaphragm is in the first regulating cavity and the second diaphragm is in the second regulating cavity. The first regulating assembly is operatively connected to the first diaphragm for preventing fluid flow through the first flow path. The second regulating assembly is operatively connected to the second diaphragm for preventing fluid flow through the second flow path. The second flow path has a constriction and the regulating assembly having a closure member for covering the constriction to prevent the fluid flow through the fluid path. The constriction has an entrance and an exit whereby fluid flows through the constriction from the inlet tube and the entrance and out of the constriction through the exit, with the closure member covering the exit of the constriction. The constriction is directly adjacent the outlet tube such that fluid traveling through the regulator housing can flow from the constriction to the outlet tube without entering the first or second cavities and without encountering the first or second diaphragms.

A further aspect of the present invention is to provide a two-stage pressure regulator comprising a regulator housing, a first diaphragm, a second diaphragm, a first regulating assembly, a second regulating assembly, and an excess flow device. The regulator housing comprises a bonnet, a first regulator body connected to the bonnet, and a second regulator body connected to the first regulator body. The regulator body has a first flow path and a second flow path, with the first flow path being located between the inlet tube and the second flow path and the second flow path being located between the first flow path and the outlet tube. The regulator housing has a first regulating cavity formed between the first regulating body and the second regulating body and a second regulating cavity formed between the bonnet and the first regulating body. A first diaphragm is in the first regulating cavity and a second diaphragm in the second regulating cavity. The first regulating assembly is operatively connected to the first diaphragm for preventing fluid flow through the first flow path at a first section and the second regulating assembly is operatively connected to the second diaphragm for preventing fluid flow through the second flow path at a second section. The excess flow device is located in the regulator housing between the first section and the second section, the excess flow device preventing excess flow of fluid to the second section from the first section.

These and other aspects, objects, and features of the present invention will be understood and appreciated by those skilled in the art upon studying the following specification, claims, and appended drawings.

### BRIEF DESCRIPTION OF THE DRAWINGS

The following brief description of the figures, and the related figures themselves, exemplifies a particular preferred embodiment of the invention constituting the best mode presently contemplated. As will be understood, other embodiments of the invention as well as changes and variations in the particular structure shown in these figures are no doubt possible, and may very well suggest themselves to those skilled in the art after studying this disclosure and these figures.

FIG. 1 is a top view of a pressure regulator in accordance with the present invention;

FIG. 2 is a side view of the pressure regulator in accordance with the present invention;

FIG. 3 is a cross-sectional view of the pressure regulator in accordance with the present invention taken along the line III-III of FIG. 2;

FIG. 4 is a cross-sectional view of the pressure regulator in accordance with the present invention taken along the line IV-IV of FIG. 1;

FIG. 5 is a bottom view of the pressure regulator in accordance with the present invention; and

FIG. 6 is a cross-sectional view of a modified pressure regulator with an excess flow feature.

### DETAILED DESCRIPTION OF PREFERRED EMBODIMENT

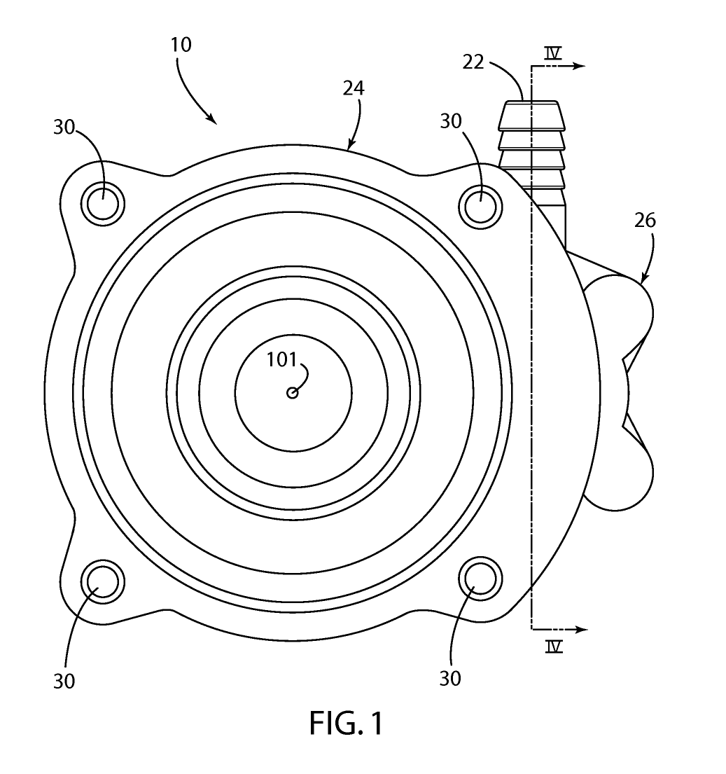

For purposes of description herein, the terms “upper,” “lower,” “vertical,” and derivatives thereof shall relate to the invention as orientated in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

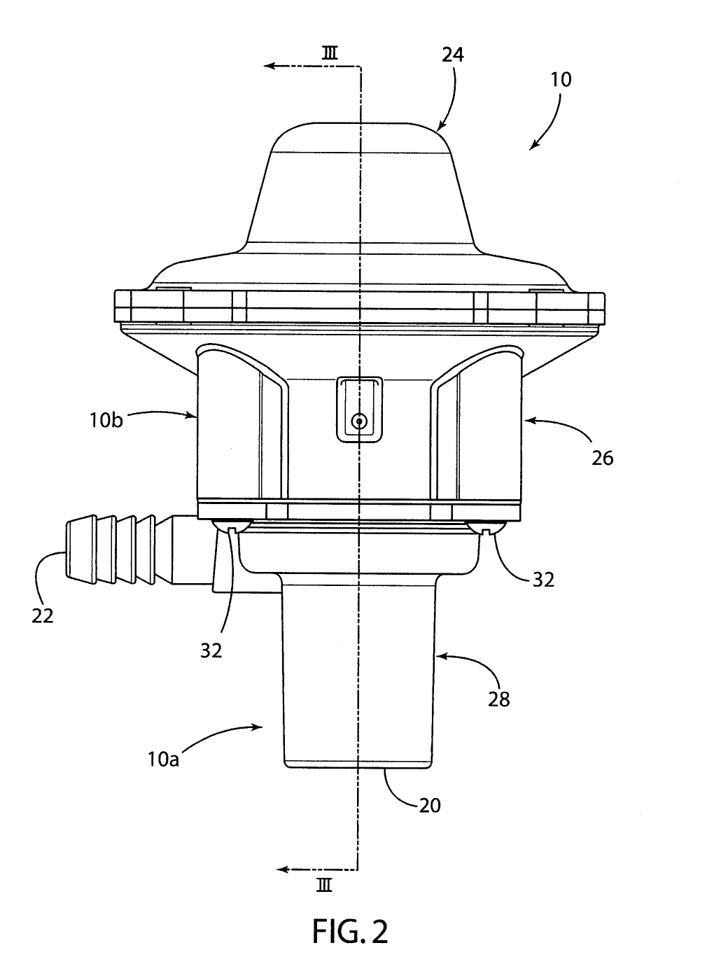

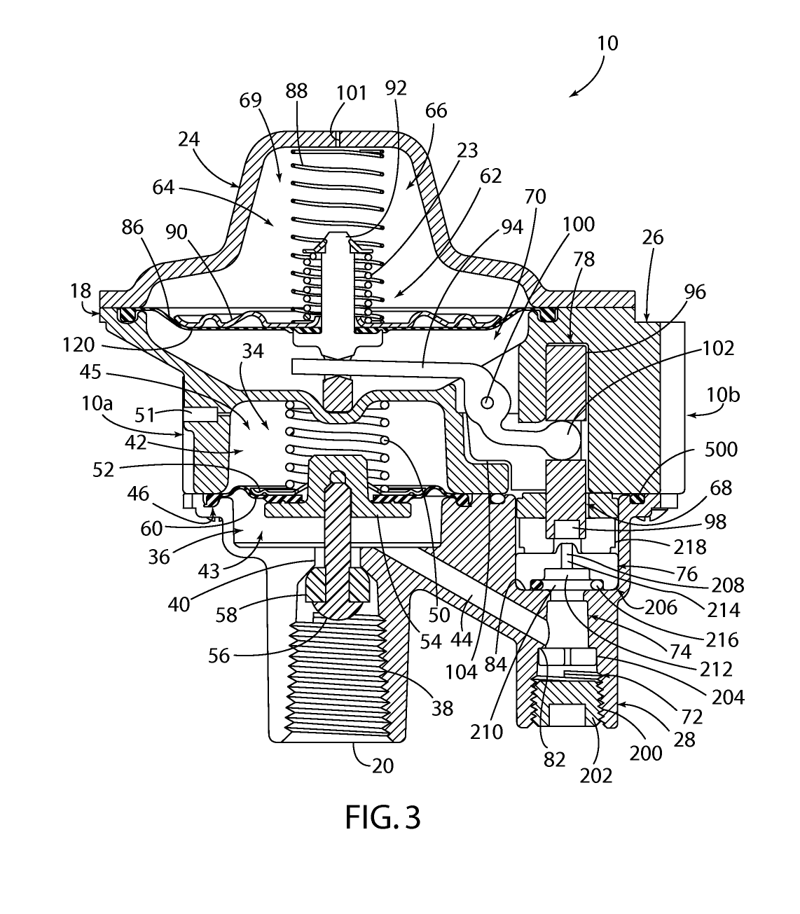

The reference number 10 (FIGS. 1-5) generally designates a two-stage gas pressure regulator embodying the present invention. In the illustrated example, the two-stage gas pressure regulator 10 includes a first regulator portion 10a having a high-pressure regulator and a second regulator portion 10b having a low-pressure regulator. The first regulator portion 10a includes an inlet 20 which receives gas from a separate gas storage container (not shown). In operation, the first regulator portion 10a having the high-pressure regulator processes gas input from the inlet 20 by reducing the pressure of the received gas to a predetermined level. The lower-pressure gas is then transmitted to the second regulator portion 10b having the low-pressure regulator for further reducing the gas pressure to a level that is suitable for use in, e.g., an appliance. As shown in FIGS. 1-5, the second regulator portion 10b includes an outlet 22 for transmitting the gas to the appliance.

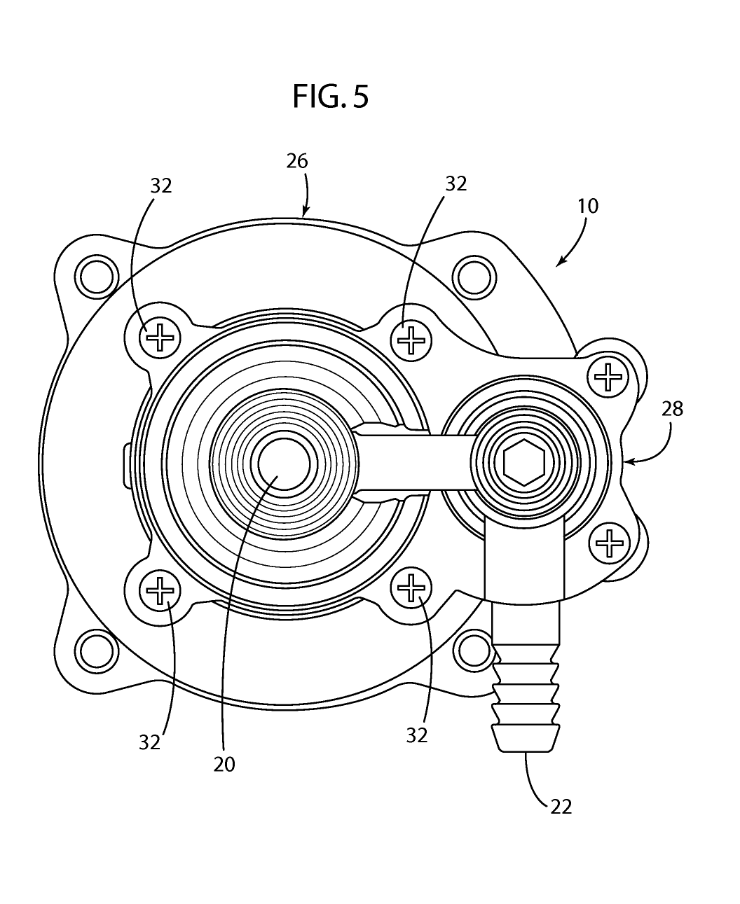

In the illustrated embodiment, the two-stage pressure regulator has an upper body 24 (sometimes called the “bonnet”), a middle body 26 and a lower body 28. The middle body 26 and the lower body 28 are preferably made by die casting. It is contemplated that the upper body 24 can be made by die casting or by stamping, among other methods. The middle body 26 is connected to the upper body 24 by a plurality of rivets 30. Alternatively, the middle body 26 could be connected to the upper body 24 by mechanically deforming, or crimping, an upstanding flange on the outside of an upper portion of the middle body 26 over an outer flange of the upper body 24. The crimp could also be reversed with a downward flange on the outside of the lower end of the upper body 24 and an outer flange on the middle body 26. Alternatively, the upper body 24 can have an outer flange at a lower end, which connects to an upper portion 18 of the middle body 26 by a plurality of threaded fasteners. As illustrated in FIG. 5, the lower body 28 is connected to the middle body 26 by a plurality of threaded fasteners 32. However, it is contemplated that the middle body 26 and the lower body 28 could be connected with a crimpled flange as used with the upper body 24 and the middle body 26 or by rivets. The middle body 26 and the lower body 28 define the first regulator portion 10a. Furthermore, the upper body 24, the middle body 26 and the lower body 28 define the second regulator portion 10b. A bottom surface of the lower body 28 has the inlet 20 and a side surface of the lower body 28 has the outlet 22 positioned perpendicular to the inlet 20. In use, the inlet 20 has a probe therein for connection to a source of fuel, e.g., gas (not shown), and the outlet 22 is connected to an outdoor cooking appliance (not shown).

In the illustrated example, the first regulator portion 10a of the two-stage gas pressure regulator 10 includes a first regulating assembly 34 for controlling the flow of fluid from the inlet 20 to the second regulator portion 10b. The first regulating assembly 34 is located within a first regulator cavity 36 defined by the middle body 26 and the lower body 28. The first regulator cavity 36 includes a lower threaded aperture 38 that ends at the inlet 20, a constriction 40 and an upper cavity area 42. The constriction 40 is located between the lower threaded aperture 38 and the upper cavity area 42. The lower threaded aperture 38 and the constriction 40 are located in the lower body 28. The upper cavity area 42 includes a first portion 43 in the lower body 28 above the constriction 40 and a second portion 45 in a lower portion of the middle body 26 that is substantially co-extensive with the first portion 43 of the upper cavity area 42 in the lower body 28. The lower body 28 also includes a passage hole 44 that allows gas to pass from the first portion 43 of the upper cavity area 42 in the lower body 28 to the second regulator portion 10b.

The illustrated first regulating assembly 34 includes a first diaphragm 46, a first spring 50, a first plate 52, a first post 54, a first stem 56 and a first regulating disc 58. The first diaphragm 46 is clamped between the lower body 28 and the middle body 26, thereby defining the first portion 43 and the second portion 45 of the upper cavity area 42. The first plate 52 is located on top of the first diaphragm 46. The first spring 50 abuts against a top of the second portion 45 of the upper cavity area 42 and the first plate 52. The first diaphragm 46 is biased downwardly by the first spring 50, which acts against the top of the first diaphragm 46 (via the first plate 52). The first diaphragm 46 is connected to the first post 54, which extends through the first diaphragm 46 and is connected to the first stem 56. The first post 54 moves the first stem 56 vertically to move the first stem 56 vertically in a reciprocal motion through the constriction 40. The first regulating disc 58 is connected to a lower end of the first stem 56 adjacent the constriction 40. The first regulating disc 58 is preferably made of rubber, although other compositions are contemplated. The first regulating disc 58 controls the amount of gas allowed to flow from the inlet 20 through the constriction 40 and to the passage hole 44 by selectively covering the constriction 40.

During typical use of the illustrated pressure regulator 10, fluid flows through the first regulator portion 10a from the source of fuel, though the inlet 20 (typically via the probe), through the first regulator cavity 36 of the first regulator portion 10a and to the passage hole 44. However, when pressure in the first portion 43 of the upper cavity area 42 of the first regulator cavity 36 raises above a certain level, the gas in the first portion 43 of the upper cavity area 42 of the first regulator cavity 36 will press against an underside 60 of the first diaphragm 46 and move the first diaphragm 46 upward against the bias of the first spring 50. Preferably, the second portion 45 of the upper cavity area 42 includes a hole 51 to the outside of the pressure regulator 10, such that the air in the second portion 45 of the upper cavity area 42 is at atmospheric pressure. In this situation, the upward movement of the first diaphragm 46 will cause the first spring 50 to compress, thereby forcing the first post 54 upwards. Upward movement of the first post 54 will force the first stem 56 to also move upward, thereby forcing the first regulating disc 58 to cover the constriction 40. Accordingly, when the pressure in the first regulator cavity 36 below the first diaphragm 46 is above a certain level, the first regulating disc 58 will cover the constriction 40 and prevent fluid flow through the constriction 40 of the first pressure regulator portion 10a.

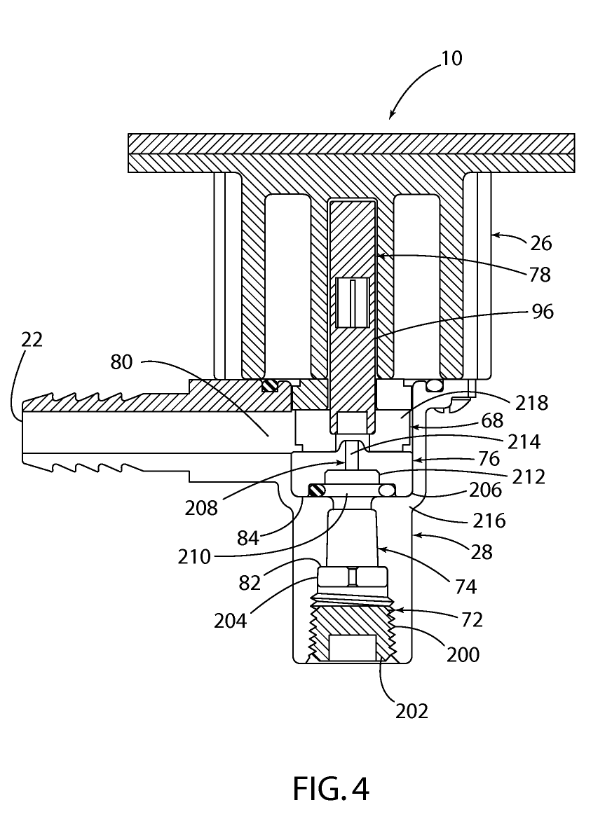

In the illustrated example, the second regulator portion 10b of two-stage gas pressure regulator 10 includes a second regulating assembly 62 for controlling the flow of fluid from the first regulator portion 10a to the outlet 22. The second regulating assembly 62 is located within a second regulator cavity 64 defined by the upper body 24, the middle body 26 and the lower body 28. The second regulator cavity 64 includes an upper first area 66 and a lower second area 68. The upper first area 66 includes a first area upper portion 69 defined by the upper body 24 and a first area lower portion 70 in the top of the middle body 26. The first area upper portion 69 and the first area lower portion 70 are substantially co-extensive. The lower second area 68 is located below and to the side of the upper first area 66. The lower second area 68 includes a lower cavity 72 substantially parallel to and adjacent the lower threaded aperture 38 of the first regulator cavity 36, a middle opening 74 above the lower cavity 72, an upper orifice 76 above the middle opening 74, and a stem tube 78 above the upper orifice 76. The lower cavity 72, the middle opening 74, the upper orifice 76 and the stem tube 78 are all preferably substantially tubular and have a common axis. The lower cavity 72, the middle opening 74 and the upper orifice 76 are located in the lower body 28 and the stem tube 78 is located in the middle body 26. A first shelf 82 defines a transition between the lower cavity 72 and the middle opening 74. Furthermore, a second shelf 84 defines a transition between the middle opening 74 and the upper orifice 76. The passage hole 44 opens to the middle opening 74. Furthermore, an outlet tube 80 extends from the upper orifice 76 to the outlet 22 (see FIG. 4). The outlet tube 80 is preferably substantially perpendicular to the common axis of the lower cavity 72, the middle opening 74, the upper orifice 76 and the stem tube 78. A channel 104 extends between the lower second area 68 and the upper orifice 76, thereby fluidly connecting the first area lower portion 70 of the upper first area 66 to the lower second area 68. Furthermore, an O-ring 500 surrounds the top of the upper orifice 76 and seals between the middle body 26 and the lower body 28.

The illustrated second regulator cavity 64 includes a plurality of elements to define a fluid path through the second regulator cavity 64 and to enclose the second regulator cavity 64. The lower cavity 72 of the lower second area 68 of the second regulator cavity 64 includes a threaded bottom 200 having a threaded first plug 202 inserted therein to enclose the second regulator cavity 64. A second plug 204 is located above the threaded first plug 202 in the lower cavity 72, with a top of the second plug 204 abutting the first shelf 82. A top of the second plug 204 also defines a bottom of the middle opening 74. An orifice constriction member 206 rests on the second shelf 84 in the upper orifice 76. The orifice constriction member 206 includes a center aperture 208 having a lower wide portion 210, a middle portion 212 and an upper narrow portion 214. An O-ring 216 is located in the lower wide portion 210 and is compressed between the second shelf 84 and the orifice constriction member 206. A spacer 218 sits on the orifice constriction member 206 between a bottom of the middle body 26 and the orifice constriction member 206. As illustrated in FIG. 4, the outlet tube 80 is located above the orifice constriction member 206.

The illustrated second regulating assembly 62 includes a second diaphragm 86, a second spring 88, a second plate 90, a second post 92, a third spring 23 between the second diaphragm 86 and the second post 92, a pivot actuator 94, a second stem 96 and a second regulating disc 98. The second diaphragm 86 is clamped between the upper body 24 and the middle body 26. The second diaphragm 86 separates the upper first area 66 into the first area upper portion 69 above the second diaphragm 86 and the first area lower portion 70 below the second diaphragm 86. The second plate 90 is located on top of the second diaphragm 86. The second spring 88 abuts against a top of the upper first area 66 and the second plate 90. The second diaphragm 86 is biased downwardly by the second spring 88, which acts against the top of the second diaphragm 86 (via the second plate 90). The second diaphragm 86 is connected to the second post 92 via the third spring 23, which extends through the second diaphragm 86 and is pivotally connected to the pivot actuator 94. The pivot actuator 94 extends through the middle body 26 and is pivotally connected to the middle body 26 by a pin 100. The pivot actuator 94 includes a lever head 102 connected to a middle of the second stem 96. The second post 92 pivots the pivot actuator 94 about the pin 100 and moves the second stem 96 vertically within the stem tube 78 to move the second stem 96 vertically in a reciprocal motion. The second regulating disc 98 is connected to a lower end of the second stem 96 adjacent a top of the orifice constriction member 206. The second regulating disc 98 controls the amount of gas allowed to flow from the passage hole 44 to the outlet 22 by selectively covering the orifice constriction member 206 to prevent flow of the gas through the center aperture 208 of the orifice constriction member 206.

During typical use of the illustrated pressure regulator 10, fluid flows through the second regulator portion 10b from the from the passage hole 44, through the lower second area 68 of the second regulator cavity 64 of the second regulator portion 10b and to the outlet 22. However, when pressure in the second regulator cavity 64 raises above a certain level, the gas in the second regulator cavity 64 will press against an underside 120 of the second diaphragm 86 and move the second diaphragm 86 upward against the bias of the second spring 88. It is noted that the fluid pressure is communicated from the lower second area 68 to the first area lower portion 70 of the upper first area 66 via the channel 104. In this situation, the upward movement of the second diaphragm 86 will cause the second spring 88 to compress thereby forcing the second post 92 upwards. Upward movement of the second post 92 will force the pivot actuator 94 to pivot about the pin 100. Therefore, the lever head 102 will force the second stem 96 to move downward, thereby forcing the second regulating disc 98 to cover the center aperture 208 of the orifice constriction member 206. Accordingly, when the pressure in the first area lower portion 70 of the second regulator cavity 64 is above a certain level, the second regulating disc 98 will cover the center aperture 208 of the orifice constriction member 206 and prevent fluid flow through the orifice constriction member 206, thereby preventing fluid flow through the second regulator portion 10b. Preferably, the first area upper portion 69 of the upper first area 66 of the second regulator cavity 64 includes a hole 101 to the outside of the pressure regulator 10, such that the air in the first area upper portion 69 is at atmospheric pressure.

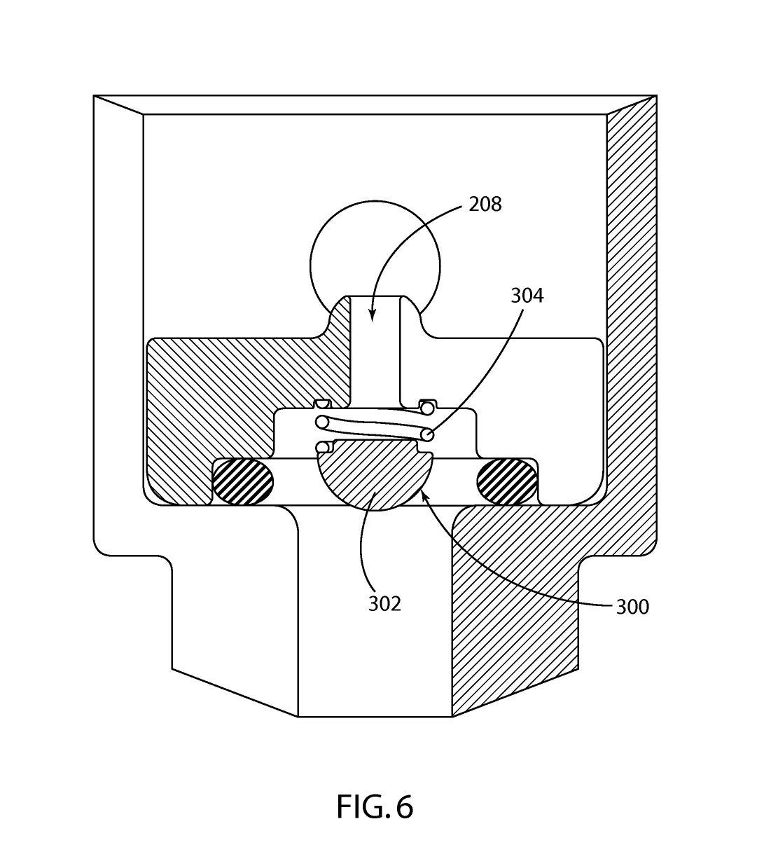

The pressure regulator of the present invention provides a simplified and very compact design. The use of only one upper body 24 (or bonnet) instead of a pair of bonnets reduces the overall cost of the regulator 10 as the bonnets can be very expensive to produce. Furthermore, locating the orifice constriction member 206 adjacent the outlet tube 80 reduces disruption of the gas flow through the regulator 10, thereby greatly reducing instability or humming (the disruption previously occurred when gas that must flow through the second regulator cavity 64 is interrupted by the second diaphragm 86 and the rest of the second regulating assembly 62). Furthermore, isolating the orifice constriction member 206 and its center aperture 208 from the second diaphragm 86 can provide a gain to the outlet flow of the gas (i.e., greater gas flow) because the distance and isolation can cause the second regulator portion 10b to remain fully open with less pressure differential between the inlet to the center aperture 208 and the outlet to the center aperture 208. Furthermore, an excess flow device 300 can be located directly before the inlet to the center aperture 208 or in the center aperture 208 that can be used to reduce the flow of gas in the event of excessive gas flow. The excess flow device 300 can be of a ball 302 and spring 304 design as illustrated in FIG. 6 or a metal flap.

Furthermore, it should be noted that in the event there is no downstream demand from the regulator for gas, gas pressure increases first inside the lower second area 68 and the first area lower portion 70 of the second regulator cavity 64 and then the first regulator cavity 36 until the sealing discs form a seal on the orifice constriction member and the constriction, respectively, causing a zero flow or lockup condition. In this regard, the described invention also includes a safety feature commonly referred to as pressure control. As described previously, the mechanism of this device operates to control output flow pressure to meet downstream demand. When demand increases, outlet pressure decreases and this results in downward movement of the diaphragms and their related parts, including the stem, causing the discs to move incrementally away from the orifice constriction member and the constriction and thereby allowing more flow through the device to supply the new demand at the same regulated pressure. This continues until the demand is satisfied and an equilibrium state is reached. Conversely, the same events occur in reverse for conditions of decreasing demand. Changes in inlet pressure and/or demand will cause the device to compensate by opening or closing the regulating assembly in response to and in accordance with the new conditions, to again reach an equilibrium state.

The described invention provides consistent repeatable performance over a wide range of inlet pressures and flow rates while also enabling significant reduction in orifice diameter and in diaphragm and overall regulator size. Furthermore, it accomplishes this by use of a simplified mechanism that is less expensive to manufacture and assemble, while at the same time providing better operating results due to the novel design, which substantially reduces function and regulating inaccuracies due to mechanical tolerance variations and lost motion inherent in less directly acting mechanisms which characterize the prior art.

The foregoing detailed description is considered that of a preferred embodiment only, and the particular shape and nature of at least some of the components in this embodiment are at least partially based on manufacturing advantages and considerations as well as on those pertaining to assembly and operation. Modifications of this embodiment may well occur to those skilled in the art and to those who make or use the invention after learning the nature of this preferred embodiment, and the invention lends itself advantageously to such modification and alternative embodiments. For example, a threaded outlet connection can be used instead of a barbed outlet. Furthermore, the regulator can include relief valves for releasing excess gas to the atmosphere. Additionally, the second regulator portion 10b could include an adjustable spring such as that disclosed in U.S. patent application Ser. No. 11/048,532 entitled PRESSURE REGULATOR WITH IMPROVED OUTLET PRESSURE CONTROL and U.S. Pat. No. 6,971,403 entitled DIRECT-ACTING PRESSURE REGULATOR, the entire contents of which are hereby incorporated herein by reference.

Therefore, it is to be understood that the embodiment shown in the drawings and described above is provided principally for illustrative purposes and should not be used to limit the scope of the invention.

I claim:

1. A two-stage pressure regulator comprising:
a regulator housing comprising a bonnet, a first regulator body connected to the bonnet, and a second regulator body connected to the first regulator body, the first regulator body having a top and a bottom, with the bonnet connected to the top of the first regulator body and the second regulator body connected to the bottom of the first regulator body, the regulator housing having an inlet and an outlet, the regulator body having a first flow path and a second flow path between the inlet and the outlet, such that the regulator body is configured to have at least some fluid flowing through the regulator body from the inlet, through the first flow path, then through the second flow path and then through the outlet;
the regulator housing having a first regulating cavity formed between the first regulating body and the second regulating body;
the regulator housing further having a second regulating cavity formed between the bonnet and the first regulating body;
a first diaphragm in the first regulating cavity;
a second diaphragm in the second regulating cavity;
a first regulating assembly operatively connected to the first diaphragm for preventing fluid flow through the first flow path; and
a second regulating assembly operatively connected to the second diaphragm for preventing fluid flow through the second flow path.

2. The two-stage pressure regulator of claim 1, wherein:
the first diaphragm is trapped between the first regulating body and the second regulating body; and
the second diaphragm is trapped between the bonnet and the first regulating body.

3. The two-stage pressure regulator of claim 1, wherein:
the first regulating cavity is located directly below the second regulating cavity.

4. The two-stage pressure regulator of claim 1, wherein:
the first regulating assembly comprises a first stem engaged with the first diaphragm, with the first stem including a first disc for covering a first constriction in the first fluid path;
the second regulating assembly comprises a post engaged with the second diaphragm, a lever connected to the post, and a second stem connected to the lever, the second stem including a second disc for covering a second constriction in the second fluid path.

5. The two-stage pressure regulator of claim 4, further including:
a first spring abutting a top of the first diaphragm, the first spring biasing the first diaphragm to a position wherein the first disc is spaced from the first constriction; and
a second spring abutting a top of the second diaphragm, the second spring biasing the second diaphragm to a position wherein the second disc is spaced from the second constriction.

6. The two-stage pressure regulator of claim 5, wherein:
the first spring abuts the first regulator body;
the second spring abuts an underside of the top of the bonnet.

7. The two-stage pressure regulator of claim 1, wherein:
the first regulating assembly prevents fluid flow through the first flow path when fluid in the first cavity is at a first pressure; and
the second regulating assembly prevents fluid flow through the second flow path when fluid in the second cavity is at a second pressure.

8. The two-stage pressure regulator of claim 1, wherein:
the second flow path has a constriction and the second regulating assembly has a closure member for covering the constriction to prevent fluid flow through the second flow path;
the constriction has an entrance and an exit whereby fluid flows through the constriction from the inlet tube and the entrance and out of the constriction through the exit, with the closure member covering the exit of the constriction; and
the constriction is directly adjacent the outlet tube such that fluid traveling through the regulator housing can flow from the constriction to the outlet tube without entering the at least one cavity, without encountering the at least one diaphragm and without encountering the connection member.

9. The two-stage pressure regulator of claim 8, wherein:
fluid flows through the constriction in a first direction and fluid flows through the outlet in a second direction, the first direction being substantially perpendicular to the second direction.

10. The two-stage pressure regulator of claim 1, wherein:
the first regulating assembly is operatively connected to the first diaphragm for preventing fluid flow through the first flow path at a first section;
the second regulating assembly is operatively connected to the second diaphragm for preventing fluid flow through the second flow path at a second section; and
further including an excess flow device located in the regulator housing between the first section and the second section, the excess flow device preventing excess flow of fluid to the second section from the first section.

11. A pressure regulator comprising:
a regulator housing having an inlet tube, an outlet tube and a fluid path between the inlet tube and the outlet tube, the regulator body having at least one regulating cavity formed therein;
at least one diaphragm in the at least one regulating cavity;
a regulating assembly operatively connected to the at least one diaphragm with a connection member for preventing fluid flow through the fluid path;
the fluid path having a constriction and the regulating assembly having a closure member for covering the constriction to prevent the fluid flow through the fluid path, the constriction having an entrance and an exit whereby fluid flows through the constriction from the inlet tube and the entrance and out of the constriction through the exit, with the closure member covering the exit of the constriction;
wherein the constriction is directly adjacent the outlet tube such that fluid traveling through the regulator housing can flow from the constriction to the outlet tube without entering the at least one cavity, without encountering the at least one diaphragm and without encountering the connection member.

12. The pressure regulator of claim 11, wherein:
fluid flows through the constriction in a first direction and fluid flows through the outlet tube in a second direction, the first direction being substantially perpendicular to the second direction.

13. The pressure regulator of claim 11, wherein:
the first regulator body having a top and a bottom, with the bonnet connected to the top of the first regulator body and the second regulator body connected to the bottom of the first regulator body.

14. The pressure regulator of claim 11, wherein:
the least one diaphragm comprises a first diaphragm and a second diaphragm;
the at least one regulating cavity comprises a first regulating cavity and a second regulating cavity;
the first regulating cavity is formed between the first regulating body and the second regulating body;
the second regulating cavity is formed between the bonnet and the first regulating body;
the first diaphragm is in the first regulating cavity; and
the second diaphragm is in the second regulating cavity.

15. The pressure regulator of claim 14, wherein:
the first diaphragm is trapped between the first regulating body and the second regulating body; and
the second diaphragm is trapped between the bonnet and the first regulating body.

16. The pressure regulator of claim 14, wherein:
the first regulating cavity is located directly below the second regulating cavity.

17. The pressure regulator of claim 14, wherein:
the fluid path includes a first fluid path section and a second fluid path section;
the regulating assembly comprises a first regulating assembly including a first stem engaged with the first diaphragm, with the first stem including a first disc for covering a first constriction in the first fluid path section;
further including a second regulating assembly comprising a post engaged with the second diaphragm, a lever connected to the post, and a second stem connected to the lever, the second stem including a second disc for covering a second constriction in the second fluid path section.

18. The two-stage pressure regulator of claim 17, further including:
a first spring abutting a top of the first diaphragm, the first spring biasing the first diaphragm to a position wherein the first disc is spaced from the first constriction; and
a second spring abutting a top of the second diaphragm, the second spring biasing the second diaphragm to a position wherein the second disc is spaced from the second constriction.

19. The two-stage pressure regulator of claim 18, wherein:
the first spring abuts the first regulator body;
the second spring abuts an underside of the top of the bonnet.

20. A two-stage pressure regulator comprising:
a regulator housing comprising a bonnet, a first regulator body connected to the bonnet, and a second regulator body connected to the first regulator body, the regulator housing having an inlet tube and an outlet tube, the regulator body having a first flow path and a second flow path, with the first flow path being located between the inlet tube and the second flow path and the second flow path being located between the first flow path and the outlet tube;
the regulator housing having a first regulating cavity formed between the first regulating body and the second regulating body and a second regulating cavity formed between the bonnet and the first regulating body;
a first diaphragm in the first regulating cavity;
a second diaphragm in the second regulating cavity;
a first regulating assembly operatively connected to the first diaphragm for preventing fluid flow through the first flow path; and
a second regulating assembly operatively connected to the second diaphragm for preventing fluid flow through the second flow path;
the second flow path having a constriction and the regulating assembly having a closure member for covering the constriction to prevent the fluid flow through the fluid path, the constriction having an entrance and an exit whereby fluid flows through the constriction from the inlet tube and the entrance and out of the constriction through the exit, with the closure member covering the exit of the constriction;
wherein the constriction is directly adjacent the outlet tube such that fluid traveling through the regulator housing can flow from the constriction to the outlet tube without entering the first or second cavities and without encountering the first or second diaphragms.

21. The two-stage pressure regulator of claim 20, wherein:
the first diaphragm is trapped between the first regulating body and the second regulating body; and
the second diaphragm is trapped between the bonnet and the first regulating body.

22. The two-stage pressure regulator of claim 20, wherein:
the first regulating cavity is located directly below the second regulating cavity.

23. The two-stage pressure regulator of claim 20, wherein:
the first regulating assembly comprises a first stem engaged with the first diaphragm, with the first stem including a first disc for covering a first constriction in the first fluid path;
the second regulating assembly comprises a post engaged with the second diaphragm, a lever connected to the post, and a second stem connected to the lever, the second stem including a second disc for covering a second constriction in the second fluid path.

24. The two-stage pressure regulator of claim 23, further including:
a first spring abutting a top of the first diaphragm, the first spring biasing the first diaphragm to a position wherein the first disc is spaced from the first constriction; and
a second spring abutting a top of the second diaphragm, the second spring biasing the second diaphragm to a position wherein the second disc is spaced from the second constriction.

25. The two-stage pressure regulator of claim 24, wherein:
the first spring abuts the first regulator body;
the second spring abuts an underside of the top of the bonnet.

26. A two-stage pressure regulator comprising:
a regulator housing comprising a bonnet, a first regulator body connected to the bonnet, and a second regulator body connected to the first regulator body, the regulator body having a first flow path and a second flow path, with the first flow path being located between the inlet tube and the second flow path and the second flow path being located between the first flow path and the outlet tube;
the regulator housing having a first regulating cavity formed between the first regulating body and the second regulating body and a second regulating cavity formed between the bonnet and the first regulating body;
a first diaphragm in the first regulating cavity;
a second diaphragm in the second regulating cavity;
a first regulating assembly operatively connected to the first diaphragm for preventing fluid flow through the first flow path at a first section;
a second regulating assembly operatively connected to the second diaphragm for preventing fluid flow through the second flow path at a second section; and
an excess flow device located in the regulator housing between the first section and the second section, the excess flow device preventing excess flow of fluid to the second section from the first section.

27. The two-stage pressure regulator of claim 26, wherein:
the first diaphragm is trapped between the first regulating body and the second regulating body; and
the second diaphragm is trapped between the bonnet and the first regulating body.

28. The two-stage pressure regulator of claim 26, wherein:
the first regulating cavity is located directly below the second regulating cavity.

29. The two-stage pressure regulator of claim 26, wherein:
the first regulating assembly comprises a first stem engaged with the first diaphragm, with the first stem including a first disc for covering a first constriction in the first fluid path;
the second regulating assembly comprises a post engaged with the second diaphragm, a lever connected to the post, and a second stem connected to the lever, the second stem including a second disc for covering a second constriction in the second fluid path.

30. The two-stage pressure regulator of claim 29, further including:
a first spring abutting a top of the first diaphragm, the first spring biasing the first diaphragm to a position wherein the first disc is spaced from the first constriction; and
a second spring abutting a top of the second diaphragm, the second spring biasing the second diaphragm to a position wherein the second disc is spaced from the second constriction.

31. The two-stage pressure regulator of claim 30, wherein:
the first spring abuts the first regulator body;
the second spring abuts an underside of the top of the bonnet.
